(19) United States
(12) Patent Application Publication
(10) Pub. No.: US 2019/0023454 A1
(43) Pub. Date: Jan. 24, 2019

(54) AIR EXHAUST VALVE

(71) Applicant: Chia-Chen Chen, Taoyuan City (TW)

(72) Inventor: Chia-Chen Chen, Taoyuan City (TW)

(21) Appl. No.: 15/869,321

(22) Filed: Jan. 12, 2018

(30) Foreign Application Priority Data
Jul. 21, 2017 (TW) 106124531

(51) Int. Cl. B65D 30/24; F16K 24/04; F16K 15/02; F16K 17/02

(52) U.S. Cl. CPC B65D 31/14; F16K 24/04; B65D 2205/02; F16K 17/02; F16K 15/023

(57) ABSTRACT

The present disclosure provides an air exhaust valve, including a first valve body, a second valve body and a gasket. The first valve body and the second valve body are engaged with each other. The second valve body includes a first opening, a second opening, a first spacer and a second spacer. The first opening is provided within a bottom portion of the second valve body. The second opening is adjacent to and in communication with the first opening, and is provided within the bottom portion of the second valve body. The first spacer is provided within the first opening to form at least one first channel, and the second spacer is provided within the second opening to form at least one second channel. The first channel and the second channel are staggered with respect to each other.

### BACKGROUND

### 1. Technical Field

The present disclosure relates to air exhaust valves, and, more particularly, to an air exhaust valve that enables unidirectional exhaust on a packaging bag.

### 2. Description of Related Art

For the convenience of trading and carrying, some food are packaged into packaging bags to prevent contact with air or moisture, and thus to maintain its freshness and extended shelf life. However, some food has the opposite results once sealed, such as packaged coffee beans and so on. This is because the coffee beans are baked before they are put into packaging bags and sealed. After sitting in the package bags for a period of time, the coffee beans will naturally produce oxygen, carbon dioxide and other gases. However, the packaging bag is sealed, and gas cannot be effectively discharged, causing expansion of the bags. The bags are even at the risk of bursting. Furthermore, coffee beans that are exposed to gases such as oxygen and carbon dioxide in the long term are prone to deterioration.

In the prior art, an air exhaust valve has been proposed that can be applied to packaging bags. It includes a valve seat provided on the inside of a bag and a valve plate provided between the bag and the valve seat. The valve seat has a plurality of air holes, which are normally blocked by the valve plate. When there is too much gas such as oxygen and carbon dioxide in the bag, the gas will push open the valve plate and an air flow path can be formed, so that the gas can be discharged through the air flow path and the air holes provided in the bag.

However, in the prior art, the valve seat of the air exhaust valve is often designed to have a plurality of air holes, and when the volume of the food is smaller than the holes, the food may be at risk of clogging the holes, preventing the gas from being discharged smoothly outside the packaging bag. Therefore, there is a need to develop an air exhaust valve that prevents blockage of the air holes by food.

### SUMMARY

The present disclosure provides an air exhaust valve, which may include a first valve body engaged with a second valve body to form a receiving space between the first valve body and the second valve body, and a gasket provided in the receiving space. The second valve body may include a first opening formed at a bottom of the second valve body and in communication with the receiving space, a second opening positioned adjacent to the first opening and formed at the bottom of the second valve body and in communication with the first opening, a first spacer provided within the first opening and forming at least one first channel, and a second spacer provided within the second opening and forming at least one second channel, wherein the first channel and the second channel are staggered and spaced apart at a gap.

The present disclosure also provides an air exhaust valve, which may include a valve body engaged with a packaging bag to form a receiving space between the valve body and the packaging bag, and a gasket provided in the receiving space. The valve body may include a first opening formed at a bottom of the valve body and in communication with the receiving space, a second opening positioned adjacent to the first opening and formed at the bottom of the valve body and in communication with the first opening, a first spacer provided within the first opening and forming at least one first channel, and a second spacer provided within the second opening and forming at least one second channel, wherein the first channel and the second channel are staggered and spaced apart at a gap.

With the second valve body in the air exhaust valve according to the present disclosure (in other words, the at least one first channel and the at least one second channel formed in the second valve body are staggered and spaced apart at a gap), food in the packaging bag are not likely to completely block the first channel and the second channels, thereby allowing gas produced by the food inside the packaging bag to successfully escape from the packaging bag. Therefore, the air exhaust valve according to the present disclosure is able to keep the food fresh and extend its shelf life while preventing the bag from expanding or even bursting.

### BRIEF DESCRIPTION OF THE DRAWINGS

FIG. 1 is an exploded view depicting various components of an air exhaust valve in accordance with an embodiment of the present disclosure;

FIG. 2 is a cross-sectional diagram depicting the air exhaust valve on a packaging bag in accordance with the present disclosure;

FIG. 3A is a top view of a second valve body of the air exhaust valve in accordance with the present disclosure;

FIG. 3B is a bottom view of the second valve body of the air exhaust valve in accordance with the present disclosure;

FIG. 4A is an isometric cross-sectional diagram depicting the air exhaust valve in accordance with the present disclosure along the line A-A in FIG. 3A;

FIG. 4B is a cross-sectional diagram depicting the air exhaust valve in accordance with the present disclosure along the line A-A in FIG. 3A;

FIG. 5 is a schematic diagram depicting the air exhaust valve in action in accordance with the present disclosure;

FIG. 6 is a top view of the second valve body of the air exhaust valve in accordance with another embodiment of the present disclosure;

FIG. 7 is a cross-sectional diagram depicting the air exhaust valve on the packaging bag in accordance with another embodiment of the present disclosure;

FIG. 8 is an exploded view depicting various components of an air exhaust valve in accordance with a second embodiment of the present disclosure;

FIG. 9A is a top view of a second valve body of the air exhaust valve in accordance with the second embodiment of the present disclosure;

FIG. 9B is a bottom view of the second valve body of the air exhaust valve in accordance with the second embodiments of the present disclosure; and

FIG. 10 is a cross-sectional diagram depicting the air exhaust valve in accordance with the second embodiments of the present disclosure along the line A-A in FIG. 9A.

### DETAILED DESCRIPTION OF THE EMBODIMENTS

The present disclosure is described by the following specific embodiments. Those with ordinary skills in the arts can readily understand other advantages and functions of the present disclosure after reading the disclosure of this specification. The present disclosure may also be practiced or applied with other different implementations. Based on different contexts and applications, the various details in this specification can be modified and changed without departing from the spirit of the present disclosure.

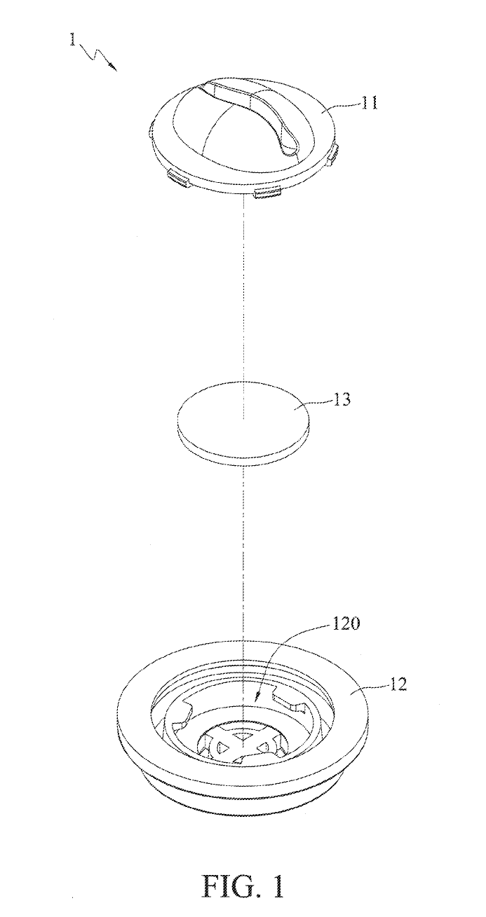

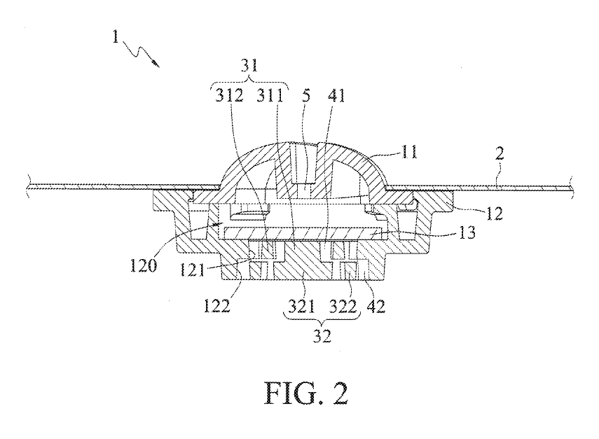

Referring to FIGS. 1 and 2 in conjunction, an air exhaust valve 1 in accordance with the present disclosure provided on a packaging bag 2 is shown. The air exhaust valve 1 includes a first valve body 11, a second valve body 12 and a gasket 13. In an embodiment, the air exhaust valve 1 is provided on the packaging bag 2 through the first valve body 11, and the second valve body 12 is engaged with the first valve body 11, such that a receiving space 120 is formed in the second valve body 12. The gasket 13 sits in the receiving space 120.

In an embodiment, between the first valve body 11 and the second valve body 12 a plurality of protrusions on the periphery of the first valve body 11 are configured for engaging with a plurality of recesses on the periphery of the receiving space 120 of the second valve body 12, such that the first valve body 11 are engaged with the second valve body 12. However, the present disclosure is not limited to this specific engaging method and structural characteristics, other methods can be used to combine the first valve body 11 and the second valve body 12.

The second valve body 12 further includes a first opening 121, a second opening 122, a first spacer 31 and a second spacer 32. In an embodiment, the first opening 121 is formed at the bottom of the second valve body 12 and in communication with the receiving space 120. The second opening 122 is positioned adjacent to the first opening 121 and is formed at the bottom of the second valve body 12 and in communication with the first opening 121. In another embodiment, the first opening 121 and the second opening 122 jointly penetrates through the bottom of the second valve body 12.

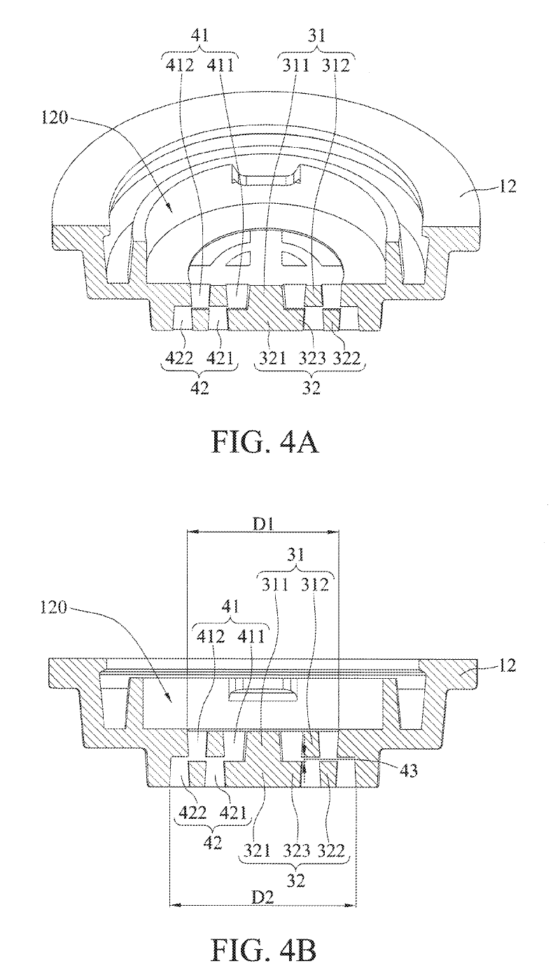

In an embodiment, the first opening 121 and the second opening 122 are circular holes. As shown in FIG. 4B, the diameter D1 of the first opening 121 is less than the diameter D2 of the second opening 122. In another embodiment, the diameter D1 of the first opening 121 is greater than or equal to the diameter D2 of the second opening 122. However, the present disclosure is not limited as such. The present disclosure does not limit the shapes of the first opening 121 and the second opening 122. For example, the first opening 121 and the second opening 122 may be square holes.

The first spacer 31 is disposed within the first opening 121 to form at least one first channel 41, and the second spacer 32 is disposed within the second opening 122 to form at least one second channel 42. Details of the first spacer 31 and the second spacer 32 are further illustrated below.

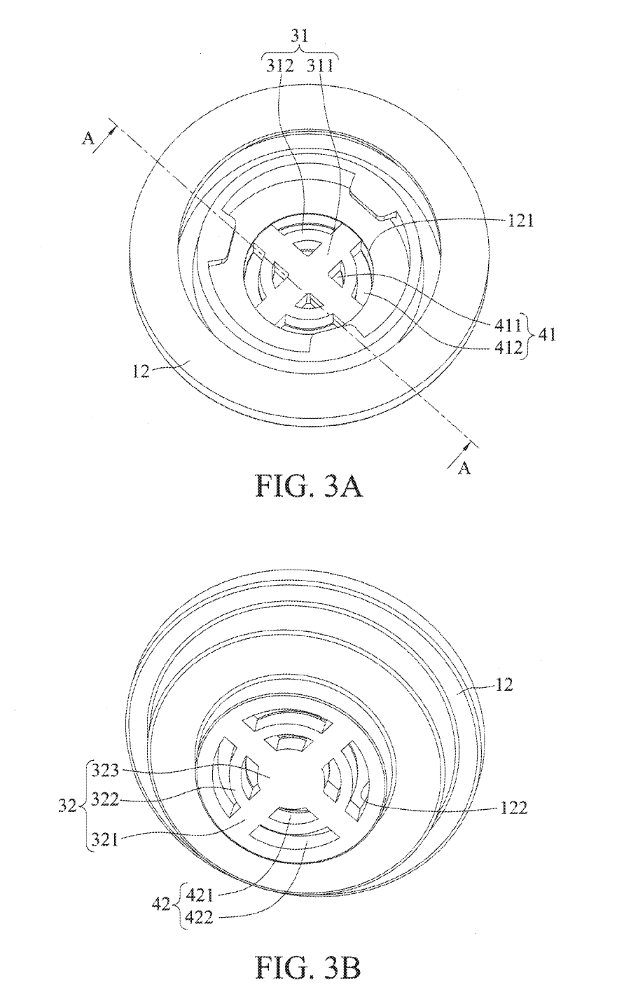

Referring to FIGS. 3A and 3B in conjunction, the first spacer 31 includes a first cross part 311 and a first annular part 312 coupled to the first cross part 311. The first cross part 311 is connected with the inner wall of the first opening 121 via the four ends of its cross. As such, the first cross part 311 is laterally disposed across the first opening 121, thereby dividing the first opening 121 into four sections (i.e., four first channels 41). The first annular part 312 is coupled to the first cross part 311 by circling the four ends of the cross of the first cross part 311 in such a way that the first annular part 312 is also laterally disposed in the first opening 121, and further divides the four first channels 41 into first inner channels 411 and first outer channels 412. In an embodiment, the first cross part 311 and the first annular part 312 divides the first opening 121 equally, such that the four first channels 41 are divided into four first inner channels 411 and four first outer channels 412.

The second spacer 32 includes a second cross part 321 and a second annular part 322 coupled to the second cross part 321. The second cross part 321 is connected with the inner wall of the second opening 122 via the four ends of its cross. As such, the second cross part 321 is laterally disposed across the second opening 122, thereby dividing the second opening 122 into four sections (i.e., four second channels 42). The second annular part 322 is coupled to the second cross part 321 by circling the four ends of the cross of the second cross part 321 in such a way that the second annular part 322 is also laterally disposed in the second opening 122, and further divides the four second channels 42 into second inner channels 421 and second outer channels 422. In an embodiment, the second cross part 321 and the second annular part 322 divides the second opening 122 equally, such that the four second channels 42 are divided into four second inner channels 421 and four second outer channels 422.

The number of the first/second channels 41/42, the first/second inner channels 411/412 and the first/second outer channels 412/422 given above are for illustrative purpose only, and the present disclosure is not so limited. Moreover, as the first annular part 312 and the second annular part 322 are embodied in a ring shape, the first channels 41 and the second channels 42 (that is, the first/second inner channels 411/412 and the first/second outer channels 412/422) have arc shapes, but the present disclosure is not so limited.

In an embodiment, the first cross part 311 and the second cross part 321 are overlapped and disposed laterally in the first opening 121 and the second opening 122, respectively, such that the locations of the first channels 41 and the second channels 42 substantially correspond to each other. However, the first cross part 311 and the first annular part 312 may be not overlapped, and are disposed laterally in the first opening 121 and the second opening 122, respectively, such that only a portion of the locations of the first channels 41 corresponds to the location of the second channels 42. However, the present disclosure is not so limited.

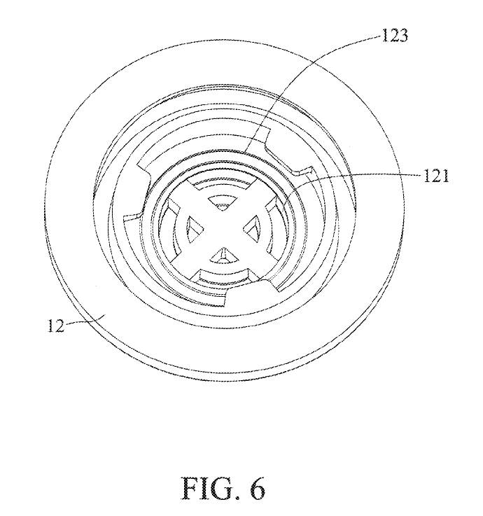

In an embodiment, referring to FIG. 6, at least one groove 123 is annularly provided on the periphery of the first opening 121 in the receiving space 120 of the second valve body 12, and has an annular shape. The number of groove 123 is preferably two or more, but the present disclosure is not so limited. As the gasket 13 is oiled before being placed in the receiving space 120, the groove 123 allows excess oil to be stored therein, thereby preventing the air exhaust valve according to the present disclosure from bursting due to oil and gas. Moreover, due to surface tension and inherent adhesion created by the oil on the groove 123 and on the surfaces of the receiving space 120 in proximity to the groove 123, the gasket 13 can be effectively secured in place without air leakage resulting from deformation of the gasket 13 caused by oil and gas.

In an embodiment, the first annular part 312 and the second annular part 322 are staggered and laterally disposed in the first opening 121 and the second opening 122, respectively. Details of this feature are further explained below with respect to FIGS. 4A and 4B.

As shown in FIGS. 4A and 4B, an annular body 323 is provided at the center of the second cross part 321 (shown in FIG. 3B). The annular body 323 can be a circular body provided at the center of the second cross part 321. The annular body 323 is also disposed in correspondence to the locations of the first inner channels 411. The first annular part 312 and the second annular part 322 are staggered in such a way that the second annular part 322 is disposed in correspondence to the locations of the first outer channels 412, and the first annular part 312 is disposed in correspondence to the locations of the second inner channels 421. In addition, there are gaps 43 between the first inner channels 411 and the second inner channels 421 and between the first outer channels 412 and the second outer channels 422, such that the first inner channels 411 are in partial communication with the second inner channels 421 and the first outer channels 412 are in communication with the second outer channels 422. In other words, the first inner channels 411 and the second inner channels 421 (and the first outer channels 412 and the second outer channels 422) are not in full communication with each other. These gaps can be realized by designing the height of the first annular part 312 to be smaller than that of the first opening 121, or the height of the second annular part 322 to be smaller than that of the second opening 122. However, the present disclosure is not limited as such, as long as the first annular part 312 and the second annular part 322 are staggered and not in contact (having gaps 43 therebetween) with respect to each other.

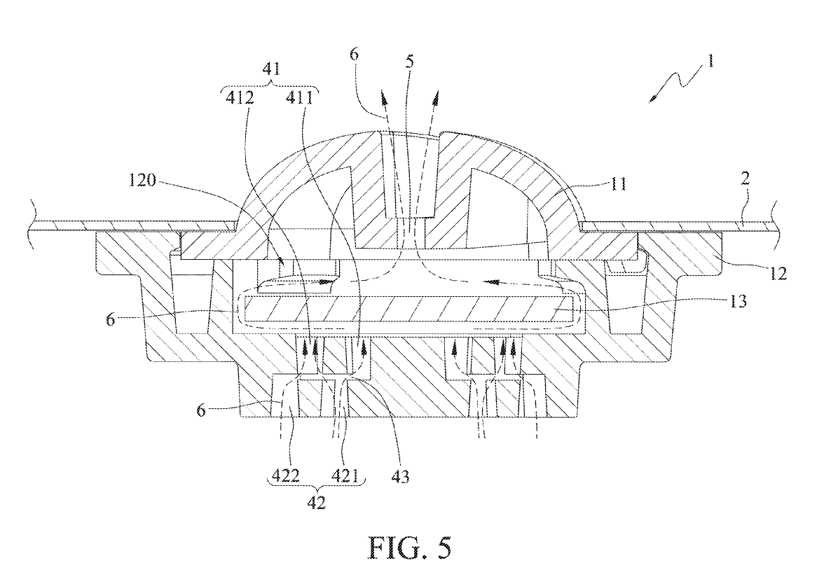

Referring to FIG. 5, the first valve body 11 includes at least one through hole 5 that penetrates its two surfaces. The through hole 5 is in communication with the first channel 41, the second channels 42, the gaps 43 and the receiving space 120 to thus form an air flow path 6. In an embodiment, the through hole 5 is formed within a groove in a protruding structure of the first valve body 11 (as shown in FIGS. 1 and 5), and a user cannot directly block the through hole 5 and the air flow path 6 can be maintained open.

During the use of the air exhaust valve 1 according to the present disclosure on the packaging bag 2, when food (e.g., coffee beans) inside the packaging bag 2 starts to produce gas, the gas passing through the air flow path 6 will first push up the gasket 13 (i.e., via the first/second inner channels 411/421 and the first/second outer channels 412/422), pass through the receiving space 120 to arrive at the through hole 5, and finally escape outside the packaging bag 2 via the through hole 5. Since the first channels 41 and the second channels 42 (i.e. the first/second inner channels 411/421 and the first/second outer channels 412/422) are in arc shapes, it is difficult for food in the packaging bag 2 to completely block the first channel 41 and the second channels 42. Also, with the design of the gaps 43 between the first channels 41 and the second channels 42, gas produced by the food inside the packaging bag 2 can successfully escape from the packaging bag 2. Therefore, the air exhaust valve of the present disclosure is able to keep the food fresh and extend its shelf life while preventing the bag from expanding or even bursting, thereby addressing the shortcomings of the prior art.

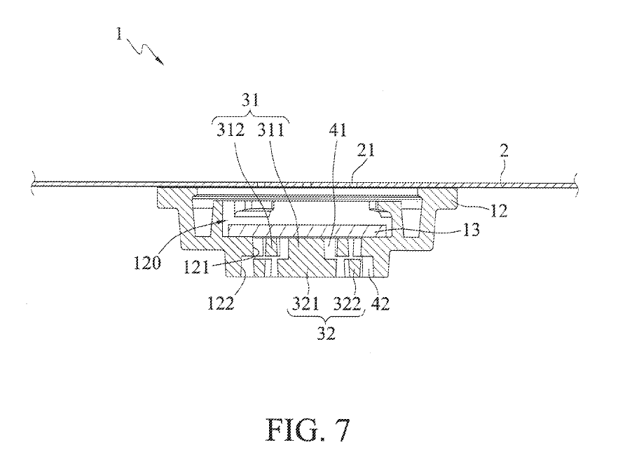

Referring to FIG. 7, another embodiment of an air exhaust valve on a packaging bag in accordance with the present disclosure is shown. The major difference between the embodiments shown in FIG. 7 and FIGS. 1 to 6 is that there is only valve body in FIG. 7, while the embodiments shown in FIGS. 1 to 6 have the first valve body and the second valve body. The differences are further illustrated below.

As shown in FIG. 7, the air exhaust valve 1 according to the present disclosure includes a valve body 12 and a gasket 13. In an embodiment, the valve body 12 is directly provided on a packaging bag 2 with at least one through hole 21. The gasket 13 is received in the receiving space 120. The through hole 21 penetrates two surfaces of the packaging bag 2. The valve body 12 further includes the first opening 121, the second opening 122, the first spacer 31 and the second spacer 32. Technical features associated with the first opening 121, second opening 122, first spacer 31 and second spacer 32 have already been described before and will not repeated.

Therefore, in addition to the implementation in which a first valve body 11 and a valve body 12 are provided on the packaging bag 2, the air exhaust valve 1 the present disclosure may also be implemented with a single valve body 12 on the packaging bag 2. In this case, the valve body 12 can be located on the packaging bag 2 with respect to the one or more through holes 21, so that the through holes 21 are in communication with the first channel 41, the second channels 42, the gaps 43 and the receiving space 120 to form the air flow path 6. In this way, the effects similar to those described in the last embodiment can be achieved, while having the advantage of a lower cost.

In an embodiment, the second valve body 12 (shown in FIG. 1 to 6) or the valve body 12 (shown in FIG. 7) of the air exhaust valve 1 in accordance with the present disclosure can be welded onto the packaging bag 2, for example, by forming ultrasonic lines on the surface of the (second) valve body 12 using ultrasonic welding. The present disclosure does not limit the method in which the (second) valve body 12 is joined with the packaging bag 2.

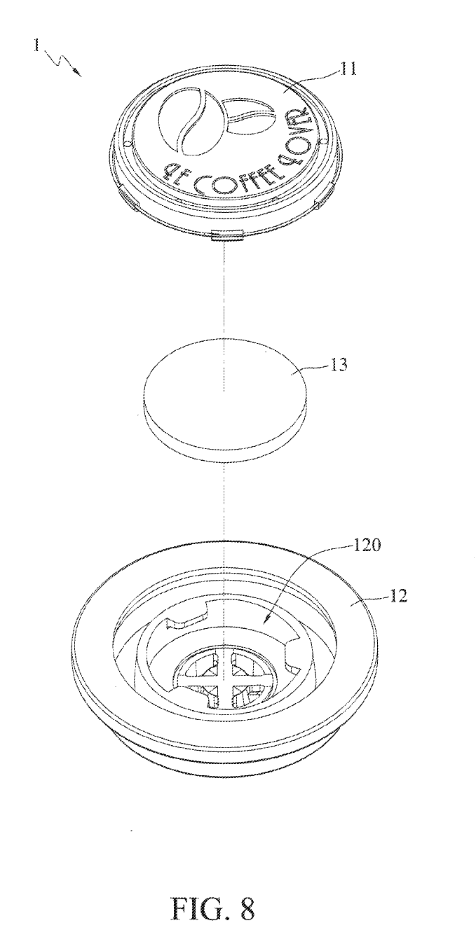

Referring to FIG. 8, an exhaust valve 1 in accordance with another embodiment of the present disclosure is shown. The air exhaust valve 1 includes a first valve body 11, a second valve body 12 and a gasket 13. In an embodiment, the air exhaust valve 1 is provided on the packaging bag 2 through the first valve body 11, and the second valve body 12 is engaged with the first valve body 11, such that a receiving space 120 is formed in the second valve body 12. The gasket 13 sits in the receiving space 120.

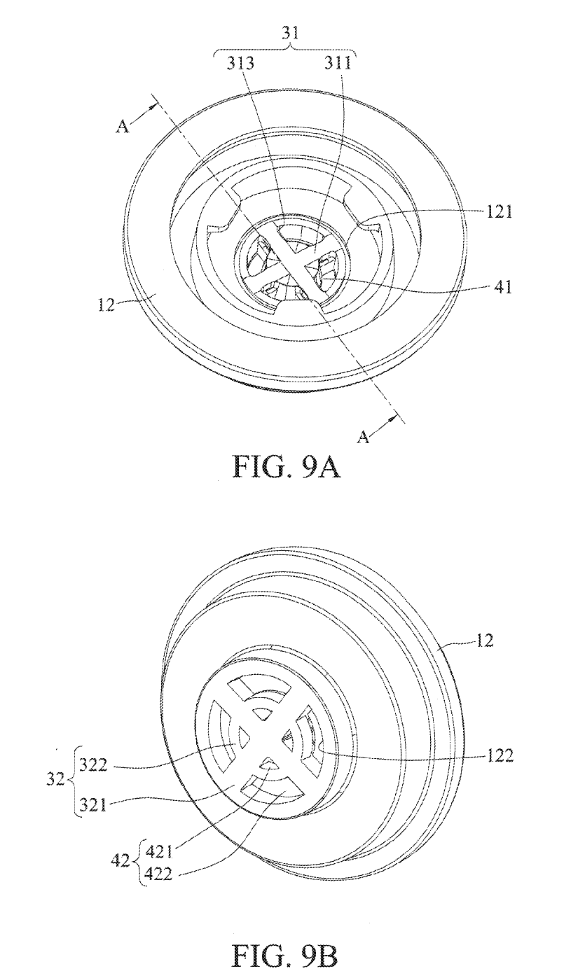

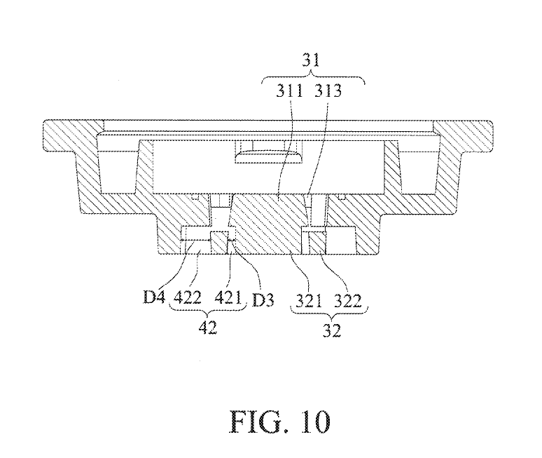

Referring to FIGS. 9A, 9B and 10 in conjunction, the first spacer 31 includes a first cross part 311 and a plurality of concave parts 313 formed at the first cross part 311. The first cross part 311 is connected with the inner wall of the first opening 121 via the four ends of its cross, and the plurality of concave parts 313 are formed at the four ends of the first cross part 311 adjacent to the inner wall of the first opening 121. As such, the first cross part 311 is laterally disposed across the first opening 121, thereby dividing the first opening 121 into four sections (i.e., four first channels 41). In an embodiment, the first cross part 311 divides the first opening 121 equally.

The second spacer 32 includes a second cross part 321 and a second annular part 322 coupled to the second cross part 321. The second cross part 321 is connected with the inner wall of the second opening 122 via the four ends of its cross. As such, the second cross part 321 is laterally disposed across the second opening 122, thereby dividing the second opening 122 into four sections (i.e., four second channels 42). The second annular part 322 is coupled to the second cross part 321 by circling the four ends of the cross of the second cross part 321 in such a way that the second annular part 322 is also laterally disposed in the second opening 122, and further divides the four second channels 42 into second inner channels 421 and second outer channels 422. In an embodiment, the second cross part 321 and the second annular part 322 divides the second opening 122 equally, such that the four second channels 42 are divided into four second inner channels 421 and four second outer channels 422, wherein a width D4 of the second outer channel 422 is larger than a width D3 of the second inner channel 421 (Referring to FIG. 10).

The above embodiments are only used to illustrate the principles of the present disclosure, and should not be construed as to limit the present disclosure in any way. The above embodiments can be modified by those with ordinary skill in the art without departing from the scope of the present disclosure as defined in the following appended claims.

What is claimed is:

1. An air exhaust valve, comprising:
a first valve body;
a second valve body engaged with the first valve body to form a receiving space between the first valve body and the second valve body, the second valve body comprising:
a first opening formed at a bottom of the second valve body and in communication with the receiving space;
a second opening formed at the bottom of the second valve body and positioned adjacent to the first opening and being in communication with the first opening;
a first spacer provided within the first opening and forming at least one first channel; and
a second spacer provided within the second opening and forming at least one second channel,
wherein the first channel and the second channel are staggered and spaced apart at a gap; and
a gasket provided in the receiving space.

2. The air exhaust valve of claim 1, wherein the first spacer includes a first cross part and a plurality of concave parts formed at the first cross part, and the first cross part equally divide the first opening; and the second spacer includes a second cross part and a second annular part coupled to the second cross part, the second cross part and the second annular part are laterally provided in the second opening, and the second cross part and the second annular part equally divide the second opening to partition the at least one second channel into at least one second inner channel and at least one second outer channel, wherein a width of the second outer channel is larger than a width of the second inner channel.

3. The air exhaust valve of claim 1, wherein the first spacer includes a first cross part and a first annular part coupled to the first cross part, the first cross part and the first annular part are laterally provided in the first opening, and the first cross part and the first annular part equally divide the first opening to partition the at least one first channel into at least one first inner channel and at least one first outer channel; and wherein the second spacer includes a second cross part and a second annular part coupled to the second cross part, the second cross part and the second annular part are laterally provided in the second opening, and the second cross part and the second annular part equally divide the second opening to partition the at least one second channel into at least one second inner channel and at least one second outer channel.

4. The air exhaust valve of claim 3, wherein the first cross part and the second cross part are overlapped and laterally provided in the first opening and the second opening, respectively, and the first annular part and the second annular part are staggered and laterally provided in the first opening and the second opening, respectively.

5. The air exhaust valve of claim 4, wherein the first opening and the second opening are circular holes, and the first opening is less than the second opening in diameter.

6. The air exhaust valve of claim 3, further comprising an annular body provided at a center of the second cross part and located in correspondence with the first inner channel.

7. The air exhaust valve of claim 3, wherein the second annular part is located in correspondence with the first outer channel, and the first annular part is located in correspondence with the second inner channel.

8. The air exhaust valve of claim 1, wherein at least one of the first channel and the second channel is in an arc shape.

9. The air exhaust valve of claim 1, wherein the first valve body includes at least one through hole penetrating two surfaces of the first valve body and being in communication with the first channel, the second channel, the gap and the receiving space to form an air flow path.

10. The air exhaust valve of claim 1, further comprising at least one groove annularly provided on a periphery of the first opening in the receiving space of the second valve body.

11. An air exhaust valve, comprising:
a valve body engaged with a packaging bag to form a receiving space between the valve body and the packaging bag, the valve body comprising:
a first opening formed at a bottom of the valve body and in communication with the receiving space;
a second opening formed at the bottom of the valve body and positioned adjacent to the first opening and being in communication with the first opening;
a first spacer provided within the first opening and forming at least one first channel; and
a second spacer provided within the second opening and forming at least one second channel,
wherein the first channel and the second channel are staggered and spaced apart at a gap; and
a gasket provided in the receiving space.

12. The air exhaust valve of claim 11, wherein the first spacer includes a first cross part and a plurality of concave parts formed at the first cross part, and the first cross part equally divide the first opening; and the second spacer includes a second cross part and a second annular part coupled to the second cross part, the second cross part and the second annular part are laterally provided in the second opening, and the second cross part and the second annular part equally divide the second opening to partition the at least one second channel into at least one second inner channel and at least one second outer channel, wherein a width of the second outer channel is larger than a width of the second inner channel.

13. The air exhaust valve of claim 11, wherein the first spacer includes a first cross part and a first annular part coupled to the first cross part, the first cross part and the first annular part are laterally provided in the first opening, and the first cross part and the first annular part equally divide the first opening to partition the at least one first channel into at least one first inner channel and at least one first outer channel; and wherein the second spacer includes a second cross part and a second annular part coupled to the second cross part, the second cross part and the second annular part are laterally provided in the second opening, and the second cross part and the second annular part equally divide the second opening to partition the at least one second channel into at least one second inner channel and at least one second outer channel.

14. The air exhaust valve of claim 13, wherein the first cross part and the second cross part are overlapped and laterally provided in the first opening and the second opening, respectively, and the first annular part and the second annular part are staggered and laterally provided in the first opening and the second opening, respectively.

15. The air exhaust valve of claim 14, wherein the first opening and the second opening are circular holes, and the first opening is less than the second opening in diameter.

16. The air exhaust valve of claim 13, further comprising an annular body provided at a center of the second cross part and located in correspondence with the first inner channel.

17. The air exhaust valve of claim 13, wherein the second annular part is located in correspondence with the first outer channel, and the first annular part is located in correspondence with the second inner channel.

18. The air exhaust valve of claim 11, wherein at least one of the first channel and the second channel is in an arc shape.

19. The air exhaust valve of claim 11, wherein the packaging bag includes at least one through hole penetrating two surfaces of the packaging bag and being in communication with the first channel, the second channel, the gap and the receiving space to form an air flow path.

20. The air exhaust valve of claim 11, further comprising at least one groove annularly provided on a periphery of the first opening in the receiving space of the valve body.
